(19) United States
(12) Patent Application Publication
(10) Pub. No.: US 2023/0306029 A1
(43) Pub. Date: Sep. 28, 2023

(54) SYSTEMS AND METHODS FOR LOADING CONTENT

(71) Applicants: Atlassian Pty Ltd., Sydney (AU); Atlassian Inc., San Francisco, CA (US)

(72) Inventors: Raymond Rui Su, Sydney (AU); Sunny Kalsi, Sydney (AU)

(21) Appl. No.: 17/704,936

(22) Filed: Mar. 25, 2022

(51) Int. Cl. G06F 16/2455; H04L 67/02; G06Q 10/06

(52) U.S. Cl. CPC G06F 16/24552; H04L 67/02; G06Q 10/063118

(57) ABSTRACT

Methods for loading virtual boards from caches are disclosed. A method includes receiving a board load request from a client device. The board load request including an identifier of a requested board. The method further includes determining whether a cache record for the requested board is present in a board cache, and upon determining that the cache record for the requested board is present in the board cache, receiving the cache record from the board cache. The cache record includes identifiers of one or more objects present in the board. The method further includes retrieving object data for at least a subset of the one or more objects present in the board; hydrating the board cache record based on the retrieved object data; and communicating the hydrated board cache record to the client device for rendering the requested board on a display of the client device.

### FIELD

The present disclosure relates generally to loading content (e.g., for web pages).

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Typically, when a page (e.g., a webpage) is requested, content for the page is retrieved from a server database (e.g., a relational database). Oftentimes, data requests are made to the server database multiple times for a single page displayed on a single user's client device. This may not severely affect the response times for that page or significantly load the server database. However, if a server handles a large number of customers and has to respond to thousands if not hundreds of thousands of data requests simultaneously, constantly retrieving data from the server database can be slow, increase response time for data requests, and severely load the server database. Further, due to the speed of the underlying hardware of such server databases, manipulating data in the server database may become a significant bottleneck.

### SUMMARY

In certain embodiments of the present disclosure a computer-implemented method for responding to a board load request is disclosed. The method includes receiving the board load request from a client device. The board load request including a board identifier of a requested board. The method further includes determining whether a cache record for the requested board is present in a board cache and upon determining that the cache record for the requested board is present in the board cache, receiving the cache record from the board cache. The cache record includes identifiers of one or more objects present in the board. The method further includes retrieving object data for at least a subset of the one or more objects present in the board, hydrating the board cache record based on the retrieved object data and communicating the hydrated board cache record to the client device for rendering the requested board on a display of the client device.

In certain other embodiments of the present disclosure a non-transitory computer readable medium is disclosed. The non-transitory computer readable medium includes instructions, which when executed by a processing unit of a computer processing system, cause the computer processing system to perform the method described above.

### BRIEF DESCRIPTION OF THE DRAWINGS

In the drawings:

FIG. 1 is an example virtual board rendered by a client system.

FIG. 2 is a block diagram of a networked environment according to some embodiments of the present disclosure.

FIG. 3 is a block diagram of a computer processing system with which various embodiments of the present disclosure may be implemented.

FIG. 4 is a flowchart illustrating an example method for responding to a virtual board request according to some embodiments of the present disclosure.

FIG. 5 is a flowchart illustrating an example method for responding to a virtual board request according to some embodiments of the present disclosure.

FIG. 6 is a flowchart illustrating a method for deleting or refreshing a board cache record according to some embodiments of the present disclosure.

While the embodiments described in the present disclosure are amenable to various modifications and alternative forms, specific embodiments are shown by way of example in the drawings and are described in detail. It should be understood, however, that the drawings and detailed description are not intended to limit the scope of an embodiment described herein to the particular form disclosed, but to cover all modifications, equivalents, and alternatives falling within the spirit and scope of the present disclosure as defined by the appended claims.

### DETAILED DESCRIPTION

In the following description, for the purposes of explanation, numerous specific details are set forth in order to provide a thorough understanding of the various embodiments described in the present disclosure. It will be apparent, however, that the embodiments described in the present disclosure may be practiced without these specific details. In some instances, well-known structures and devices are shown in block diagram form in order to avoid unnecessary obscuring.

### Overview

Aspects of the present disclosure will be described with respect to pages generated by object tracking applications that provide mechanisms for creating objects, object states, and transitioning objects between states. However, it will be appreciated that this is just an example and that aspects of the present disclosure can be implemented for other types of pages just as easily without departing from the scope of the present disclosure.

One example of an object tracking application (as referred to in the present context) is Trello. Trello allows users to create objects in the form of tasks and object states in the form of lists. In order to change a task state in Trello a task is moved from one list to another. For example, a Trello user may set up a project having the lists “To Do,” “In Progress,” and “Completed.” A user may then create tasks that need to be done and adds them to the “To Do” list: e.g., a “grocery shopping” task, a “washing up” task, an “organize house party” task etc. The user can also transition tasks between lists, e.g., by dragging or other means, from its current list to another one. For example, once the user has completed grocery shopping they can move the corresponding task from the “To Do” list to the “Completed” list. If the user has started but not yet completed work on their house party task they can move the corresponding task from the “To Do” list to the “In Progress” list.

A further example of what the present disclosure refers to as an object tracking application is Jira. Jira allows users to create objects in various forms—for example issues or, more generally, work items. A work item in Jira is an object with associated information and an associated workflow, e.g., a series of states through which the work item transitions over its lifecycle. Any desired workflow maybe defined for a given type of work item.

Object tracking applications such as those described above often provide user interfaces for displaying the current state of objects maintained by the application and allowing users to move objects (e.g., tasks in Trello, work items in Jira) between states (or lists). In both Trello and Jira such user interfaces are referred to as boards. A board (also interchangeably referred to as a virtual board herein) is generally a tool for workflow visualization. Generally speaking, a board includes cards, columns and/or swimlanes to visualize workflows in an effective manner Each card in the board may be a visual representation of an object (e.g., task in Trello, work item in Jira) and may include information about the object, such as deadlines, assignee, description, etc. Each column in the board represents a different state (e.g., stage of a workflow in Jira or a list in Trello). The cards typically progress through the columns until their completion. Swimlanes are horizontal lanes that can be used to separate different activities, teams, classes or services, etc.

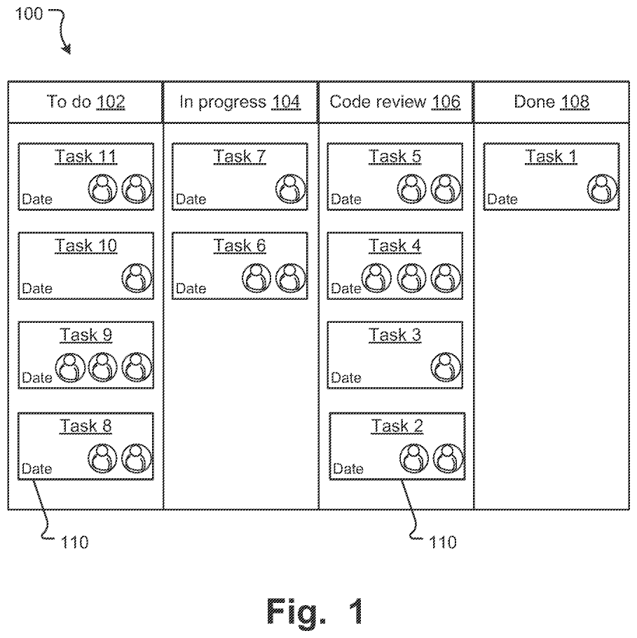

FIG. 1 provides an example virtual board 100 which shows a workflow to track software development projects. In particular, the board 100 includes four columns, each corresponding to a workflow state: TO DO 102; IN PROGRESS 104; CODE REVIEW 106; and DONE 108. Board 100 also includes several cards 110, e.g., visual representations of objects (tasks in the present context), each of which is in a particular column according to the current state of the object. Each card may include information about the underlying object —.e.g., it may include an object title and description, a date by which the object is to be completed or was completed and one or more user assigned to complete the object.

Aspects of the present disclosure will be described with respect to loading of such virtual boards 100.

Typically, to render a virtual board, such as board 100, multiple data requests are made to a backend server database for board data. For instance, a first request may be made for the data required to generate a first meaningful paint (that is, to render the primary content of the visible portion of the board 100). This may include, e.g., the board name, number of columns, column names, visible cards, etc. A second request may be made for non-critical data (e.g., non-visible cards in each column) and a third request may be made in case server-side rendering is used and the server times out before the entire board is rendered. For each data request, the server database retrieves and communicates the entire board data to the requesting server application and/or client device. These multiple data requests create a significant load not only on the server database but are also a performance bottleneck as the same data is requested from the server database multiple times.

To overcome one or more of these issues, aspects of the present disclosure utilize a server-side cache. In particular, aspects of the present disclosure store board data in a temporary, short-lived, server-side cache. The first time data for a board is requested, it may be retrieved from the server database and stored in the cache. Each subsequent data request associated with that board can be fulfilled from the cache without having to go back to the server database. This way, instead of retrieving data for a board multiple times from the server database, it can be retrieved from the server database once, thereby reducing the load on the database. Further as future requests are fulfilled from the cache, which is a fast low-latency memory, latency in rendering the board can be reduced.

In some embodiments, the cache may store board data for each user that requested the data in the form of individual records (also referred to as per-user board cache records). In this case, user level permissions may be applied before board data is stored in the cache such that only data the user is permitted to view is stored in the user's board cache record. Further, in such cases, each board cache record may have a very short time to live (TTL), e.g., a few seconds. This way, any given board cache record is available to provide data to load the corresponding board for a given user but is terminated shortly thereafter. The next time the same board needs to be loaded for the same user, e.g., if the user refreshes the screen, a new short-lived board cache may be created. This way, if permissions change between loads, the system does not erroneously serve data to a client device that a user does not have permission for. Further because of the short TTL, if the board data is updated between loads, the cache has and serves updated data to the client device instead of serving stale data.

In other embodiments, the cache may store data for individual board in the form of individual records (also referred to as per-board cache records). That is, the cache may maintain a single instance of board data for a given board. The first time any user requests a virtual board, data for the board is retrieved from the server database and stored in the cache. Thereafter if the same user or any other user requests that same board, board data is served from the cache instead of the main database. In this case, aspects of the present disclosure further reduce the burden on the server database and improve the latency to display boards as only a first board request is served from the server database and subsequent requests for the same user and other users are served from the cache.

In case per-board cache records are maintained, when a request for loading a board is received, the systems and methods disclosed herein can determine the permissions associated with the requesting user and filter the board data based on those permissions so that only data the user is permitted to view is communicated to the requesting client device. As a per-board cache record may be used to serve multiple users, it may have a longer TTL (e.g., an hour, 6 hours, etc.).

Further still, in some embodiments, the TTL for per-board cache records may be determined based on one or more trigger conditions. For example, in some cases a cache record may be flushed upon determining that the data in that cache record is stale. In other cases, instead of flushing board data upon determining that the cache record is stale, the systems and methods disclosed herein may update the cache record. To this end, the disclosed systems and methods may monitor board events generated when the underlying board data is updated. Whenever a determination is made that data for a particular cache record is updated (e.g., a new card is added, a card is moved from one column to another, or a card is deleted), the corresponding cache record may be flushed and a new cache record may be created based on the updated data. Alternatively, just the board data in the cache record may be updated based on the information in the monitored event.

### Example Systems

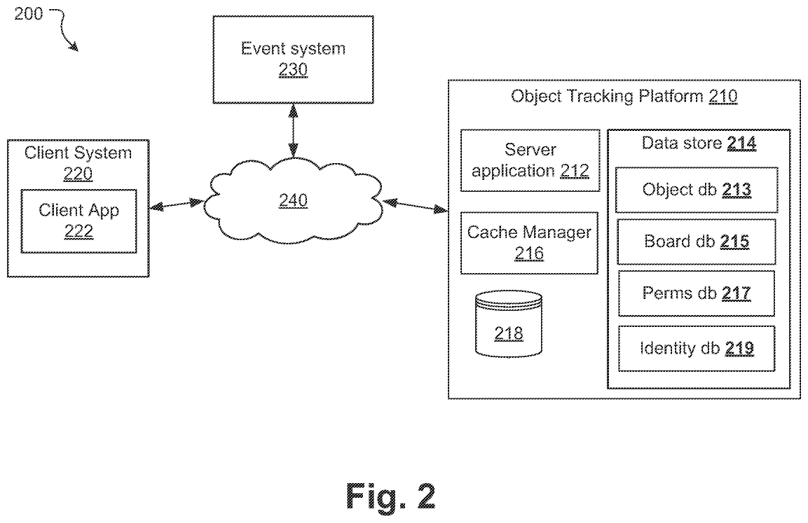

FIG. 2 illustrates a networked environment 200 in which one or more aspects of the present disclosure are implemented. Specifically, FIG. 2 illustrates the various systems involved in loading a board 100 on a client device according to embodiments of the present disclosure. The networked environment 200 includes an object tracking platform 210 and a client system 220.

Generally speaking, the object tracking platform 210 may be a computer processing system or set of computer processing systems configured to provide an object tracking application used (inter alia) to create, manage, and track objects. Object tracking platform 210 may, however, provide other services/perform other operations. In order to provide such services/operations, the object tracking platform 210 includes a server application 212 and a main data store 214.

The server application 212 is executed by one or more computer processing systems to provide server-side functionality to a corresponding client application (e.g., client application 222 as discussed below). In one example, the server application 212 is configured to cause display of a board (e.g., virtual board 100) on a client system 220. Further, the server application 212 is configured to receive data requests from client systems 220 to load or update virtual boards and responds to these data requests. For example, when the server application 212 receives a request to load a virtual board, it may respond with data defining the structure (e.g., styling information), content (e.g., the actual data to be displayed on the web page), and behavior (e.g., interactive components) of the virtual board. Further, the server application 212 may be configured to receive data update instructions from the client systems 220 (e.g., to add a new card to a board, move a card from one column to another, delete a card on a board, add or delete a column of the board, etc.) and may be configured to perform actions based on these instructions, e.g., it may update the main data store 214 based on the received data update instructions. In addition to the above, the server application 212 may also receive board event data from the client systems 220. The board event data may be generated each time a user interacts with a board user interface on a client device. For example, each time a user updates a given card 110 in a board, moves a card 110, etc. The server application 212 may be configured to communicate this board event data to a suitable server system, such as event system 230.

The server application 212 comprises one or more application programs, libraries, APIs or other software elements that implement the above-described features and functions. For example, where the client application 222 is a web browser, the server application 212 is a web server such as Apache, IIS, nginx, GWS, or an alternative web server. Where the client application 222 is a specific/native application, server application 212 is an application server configured specifically to interact with that client application 222. In some embodiments, the server application 212 may be provided with both web server and application server applications.

The main data store 214 includes one or more databases management systems (DBMS) and one or more databases 213, 215, 217, 219 (operating on one or multiple computer processing systems). Generally speaking, the DBMS receives structured query language (SQL) queries from a given system (e.g., server application 212 or cache manager 216), interacts with the one or more databases 213, 215, 217, 219 to read/write data as required by those queries, and responds to the relevant system with results of the query.

The data store 214 may store any data relevant to the services provided/operations performed by the server application 212. By way of a specific example, the data store 214 stores an object database 213, a board database 215, a permissions database 217, and an identity database 219.

The object database 213 stores data related to objects (e.g., tasks or issues) that are maintained and managed by the object tracking system. In this case, various data can be maintained in respect of a given object, for example: an object identifier; an object state; a team or individual to which the object has been assigned; an object description; an object severity; a service level agreement associated with the object; a tenant to which the object relates; an identifier of a creator of the object; a project to which the object relates; identifiers of one or more objects (parent objects) that the object is dependent on; identifiers of one or more objects (children objects) that depend on the object; identifiers of one or more other stakeholders; and/or other data.

Data for an object may be stored across multiple database records (e.g., across multiple database tables) that are related to one another by one or more database keys (for example object identifiers and/or other identifiers).

The board database 215 stores data related to virtual boards maintained by the platform 210. This includes, e.g., for each virtual board, a board identifier, a board name, a board description, a creator of a board, number of columns in the board, number of swimlanes in the board, names of columns and/or swimlanes in the board, a list of objects that are part of the board and a list of assignees associated with those objects. As used herein, such board data is referred to as board scope data. The board scope data may be stored in one or more tables or storage devices as board scope records, where each record corresponds to a given board.

The object tracking platform 210 may host a permission based application—that is, at least some data hosted by the object tracking platform 210 may have restricted access. In some examples, the platform 210 utilizes role based access control or permissions for such data. For instance, it may have three classes of permissions—global, project and object permissions. Global permissions allows users to access all data maintained by the server application 212. Project permissions allow or restrict users from accessing data associated with a particular project created in the object tracking application and object permissions allow or restrict users from accessing a specific object within a project. Further, for each class, permissions may be further configurable. For example, a role may have permission to view a given project, but may not have permission to create, delete, or edit objects in that project. Similarly, another role may be able to perform all these actions in a given project, but may not be allowed to edit the workflow or column structure in a virtual board.

The permissions database 217 is configured to maintain such permission data for the object tracking platform 210. That is, the permissions database 217 maintains records of permissions associated with individual objects available in the object database 213. Further, the permissions database 217 is configured to receive permission check queries for one or more user identifiers from other systems (e.g., the server application 212 or the cache manager 216), check whether the given user identifier has permission to access the one or more requested data resources (e.g., a board, or a card displayed in a board), and return a response to the permission check query.

The identity database 219 stores user information. Typically, in a software application, users are identified by unique user identifiers. In some cases, the same user identifiers may be utilized to identify a user across multiple products. In other examples, different user identifiers may be utilized. The identity database 219 manages and links the various user identifiers used by the object tracking application. This way identity can be federated across product applications. Further the identity database 219 may maintain personal user information for users that is shared with the various product platforms—e.g., the user name, position, organization division, years employed by the organization, date of birth, profile picture etc. The cache manager 214 may query the identity database 219 from time to time to retrieve user information for user identifiers (e.g., to add to one or more cards in a board).

Although the various databases 213, 215, 217, and 219 are depicted as being part of the main data store 214, these databases may also be maintained as in-memory caches. Further, one or more of these databases may be maintained as separate entities with their own DBMS. For example, the permissions database 217 may be an independent permissions system that not only stores permission data for the object tracking platform 210 but may also store permission data for other product applications. Similarly, the identity database 219 may be a federated identity platform that maintains user identity across a number of product applications.

In order to provide caching capabilities, the object tracking platform 210 further includes a cache manager 216 and a cache 218.

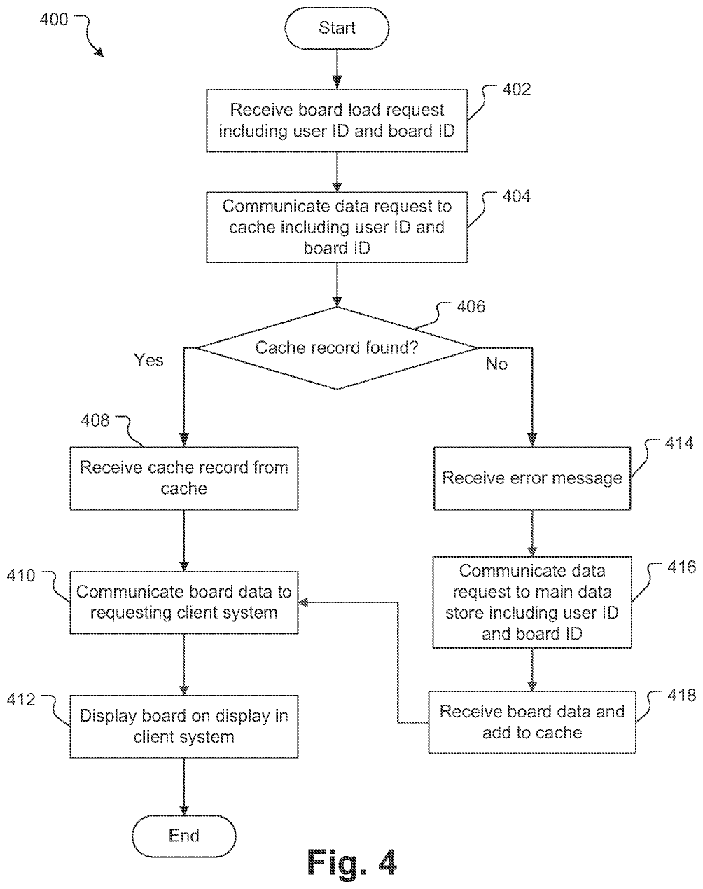

The cache manager 216 is configured to receive data requests from the server application 212 and respond to these requests with data either from the cache 218 or from the main data store 214. Further, if data is not found in the cache 218, the cache manager 216 is configured to store data retrieved from the main data store 214 in the cache 218 when responding to a data request. These and other functions of the cache manager 216 will be described with reference to FIGS. 4-7.

The cache 218 stores a subset of the data stored in the main data store 214. In particular, the cache 218 stores per-user board cache records and/or per-board cache records. In case, a per-user board cache record is stored, the record may include board scope data, object data, and assignee data within the record. In case, a per-board cache record is stored, the record may include the board scope data. Further, in some embodiments, the records may be stored against corresponding unique cache keys.

The cache 218 may be implemented on a single physical computer or hardware component (also referred to as a memory resource hereinafter). In other examples, the cache 218 may pool the memory of multiple memory resources into a single in-memory data store or cluster. In the distributed arrangement, the cache 218 may expand incrementally by adding more memory resources to the in-memory data store or cluster. In one example, the cache 218 may be implemented using Redis, a distributed memory-caching system.

Further, the cache records may have a finite TTL. This can be achieved by setting a timeout against the corresponding cache keys. After the timeout expires, the key can be automatically deleted, thereby deleting the associated board data. In other examples, board data can be evicted based on explicit trigger conditions as discussed later.

The systems of the object tracking platform 210 typically execute on multiple computer processing systems. For example, in some implementations each component of the object tracking platform 210 may be executed on a separate computer processing system. In other embodiments, multiple (or even all) components of the object tracking platform 210 may run on a single computer processing system. In certain cases a clustered server architecture may be used where applications are executed across multiple computing instances (or nodes) that are commissioned/decommissioned on one or more computer processing systems to meet system demand. For example, the cache manager 216 may be implemented as multiple nodes connected to the server application 212 via a load balancer. Further, the cache manager 216 may be logically subdivided into front end nodes and worker nodes. The front-end cache manager nodes may be configured to handle board load requests and the worker cache manager nodes may be configured to listen to the event platform (discussed below) for board events and delete or update board cache records based on the events.

Client system 220 hosts a client application 222 which, when executed by the client system 220, configures the client system 220 to provide client-side functionality. This may include, for example, interacting with (e.g., sending data to and receiving data from) server application 212. Such interactions typically involve logging on (or otherwise accessing) server application 212 by providing credentials for a valid account maintained by the object tracking platform 210. As noted above, in certain embodiments the account may be associated with a particular tenant identifier. Once validated, a user can perform various functions using client application 222, for example requesting web pages, generating requests to read data from or write data to the main data store 214, automating such requests (e.g., setting requests to periodically execute at certain times), and other functions.

Client application 222 may be a general web browser application (such as Chrome, Safari, Internet Explorer, Opera, or an alternative web browser application) which accesses a server application such as server application 212 via an appropriate uniform resource locator (URL) and communicates with the server application via general world-wide-web protocols (e.g., HTTP, HTTPS, FTP). Alternatively, the client application xx32 may be a native application programmed to communicate with server application xx14 using defined application programming interface (API) calls. When the client application 222 is a web browser, its main function is to present web resources requested by the user. Further, a given client system 220 may have more than one client application 222, for example it may have two or more types of web browsers.

Client system 220 may be any computer processing system which is configured (or configurable) by hardware and/or software to offer client-side functionality. By way of example, suitable client systems may include: server computer systems, desktop computers, laptop computers, netbook computers, tablet computing devices, mobile/smart phones, and/or other computer processing systems.

In addition to the object tracking platform 210 and the client system 220, the networked environment 200 may further include an event system 230.

The event system 230 receives user account interaction events from the server application 212 and records these user account interactions as event logs or records. The event system 230 may be configured to communicate these event logs to the cache manager 216 either as a continuous stream or in batches periodically.

In some cases, the event system 230 is designed based on a publish-subscribe model. That is, object tracking platform 210 (and in particular the server application 212) sends event data to the event system 230 and consumers (such as the cache manager 216) subscribe to the event system 230 to receive certain type of event data from the event platform (e.g., board events). In this model, the publishers categorize the event data into classes (e.g., if the server application 212 runs an issue tracking system, the server application 212 may categorize board-related data, e.g., a new card, movement of a card from one column to another, deletion of a card, addition/removal of a column, rearrangement of the columns, etc. into one category) without knowledge of which subscribers there may be. Similarly, subscribers express interest in one or more classes of event data and receive event data from the event system 230 that is of interest to them. For example, the cache manager 216 may subscribe to board event category or topic. When the event system 230 receives an event log, the event system 230 determines the event category/topic and matches the event log with the subscribers who are subscribed to the determined category/topic, and makes a copy of the event data for each subscriber and stores a copy of the subscriber's queue or stream. StreamHub offered by Atlassian is one example of such an event platform.

The systems 210-230 depicted in FIG. 2 communicate with each other over a communication network 240. Communications network 240 may be a local area network, public network (e.g., the Internet), or a combination of both.

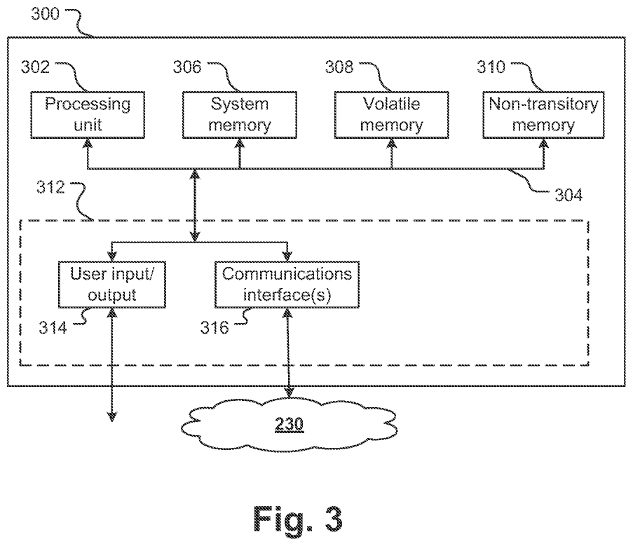

FIG. 3 provides a block diagram of a computer processing system 300 configurable to implement embodiments and/or features described herein. System 300 is a general purpose computer processing system. It will be appreciated that FIG. 3 does not illustrate all functional or physical components of a computer processing system. For example, no power supply or power supply interface has been depicted, however system 300 will either carry a power supply or be configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

Computer processing system 300 includes at least one processing unit 302—for example a general or central processing unit, a graphics processing unit, or an alternative computational device). Computer processing system 300 may include a plurality of computer processing units. In some instances, where a computer processing system 300 is described as performing an operation or function all processing required to perform that operation or function will be performed by processing unit 302. In other instances, processing required to perform that operation or function may also be performed by remote processing devices accessible to and useable by (either in a shared or dedicated manner) system 300.

Through a communications bus 304, processing unit 302 is in data communication with a one or more computer readable storage devices which store instructions and/or data for controlling operation of the processing system 300. In this example system 300 includes a system memory 306 (e.g., a BIOS), volatile memory 308 (e.g., random access memory such as one or more DRAM applications), and non-volatile (or non-transitory) memory 310 (e.g., one or more hard disks, solid state drives, or other non-transitory computer readable media). Such memory devices may also be referred to as computer readable storage media (or a computer readable medium).

System 300 also includes one or more interfaces, indicated generally by 312, via which system 300 interfaces with various devices and/or networks. Generally speaking, other devices may be integral with system 300, or may be separate. Where a device is separate from system 300, connection between the device and system 300 may be via wired or wireless hardware and communication protocols, and may be a direct or an indirect (e.g., networked) connection.

Wired connection with other devices/networks may be by any appropriate standard or proprietary hardware and connectivity protocols, for example Universal Serial Bus (USB), eSATA, Thunderbolt, Ethernet, HDMI, and/or any other wired connection hardware/connectivity protocol.

Wireless connection with other devices/networks may similarly be by any appropriate standard or proprietary hardware and communications protocols, for example infrared, BlueTooth, WiFi; near field communications (NFC); Global System for Mobile Communications (GSM), Enhanced Data GSM Environment (EDGE), long term evolution (LTE), code division multiple access (CDMA—and/or variants thereof), and/or any other wireless hardware/connectivity protocol.

Generally speaking, and depending on the particular system in question, devices to which system 300 connects—whether by wired or wireless means—include one or more input/output devices (indicated generally by input/output device interface 314). Input devices are used to input data into system 300 for processing by the processing unit 302. Output devices allow data to be output by system 300. Example input/output devices are described below, however it will be appreciated that not all computer processing systems will include all mentioned devices, and that additional and alternative devices to those mentioned may well be used.

For example, system 300 may include or connect to one or more input devices by which information/data is input into (received by) system 300. Such input devices may include keyboards, mice, trackpads (and/or other touch/contact sensing devices, including touch screen displays), microphones, accelerometers, proximity sensors, GPS devices, touch sensors, and/or other input devices. System 300 may also include or connect to one or more output devices controlled by system 300 to output information. Such output devices may include devices such as displays (e.g., cathode ray tube displays, liquid crystal displays, light emitting diode displays, plasma displays, touch screen displays), speakers, vibration applications, light emitting diodes/other lights, and other output devices. System 300 may also include or connect to devices which may act as both input and output devices, for example memory devices/computer readable media (e.g., hard drives, solid state drives, disk drives, compact flash cards, SD cards, and other memory/computer readable media devices) which system 300 can read data from and/or write data to, and touch screen displays which can both display (output) data and receive touch signals (input).

System 300 also includes one or more communications interfaces 316 for communication with a network, such as network 240 of environment 200. Via a communications interface 316 system 300 can communicate data to and receive data from networked devices, which may themselves be other computer processing systems.

System 300 may be any suitable computer processing system, for example, a server computer system, a desktop computer, a laptop computer, a netbook computer, a tablet computing device, a mobile/smart phone, a personal digital assistant, or an alternative computer processing system.

System 300 stores or has access to computer applications (also referred to as software or programs)—e.g., computer readable instructions and data which, when executed by the processing unit 302, configure system 300 to receive, process, and output data. Instructions and data can be stored on non-transitory computer readable media accessible to system 300. For example, instructions and data may be stored on non-transitory memory 310. Instructions and data may be transmitted to/received by system 300 via a data signal in a transmission channel enabled (for example) by a wired or wireless network connection over interface such as 312.

Applications accessible to system 300 will typically include an operating system application such as Microsoft Windows™, Apple macOS™, Apple iOS™, Android™ Unix™, or Linux™.

System 300 also stores or has access to applications which, when executed by the processing unit 302, configure system 300 to perform various computer-implemented processing operations described herein. For example, and referring to networked environment 200 of FIG. 2 above, client system 220 includes a client application 222 which configures the client system 220 to perform client system operations, and object tracking platform 210 includes server application 212 which configures the server environment computer processing system(s) to perform the described server environment operations.

In some cases part or all of a given computer-implemented method will be performed by a single computer processing system 300, while in other cases processing may be performed by multiple computer processing systems in data communication with each other.

### Example Methods

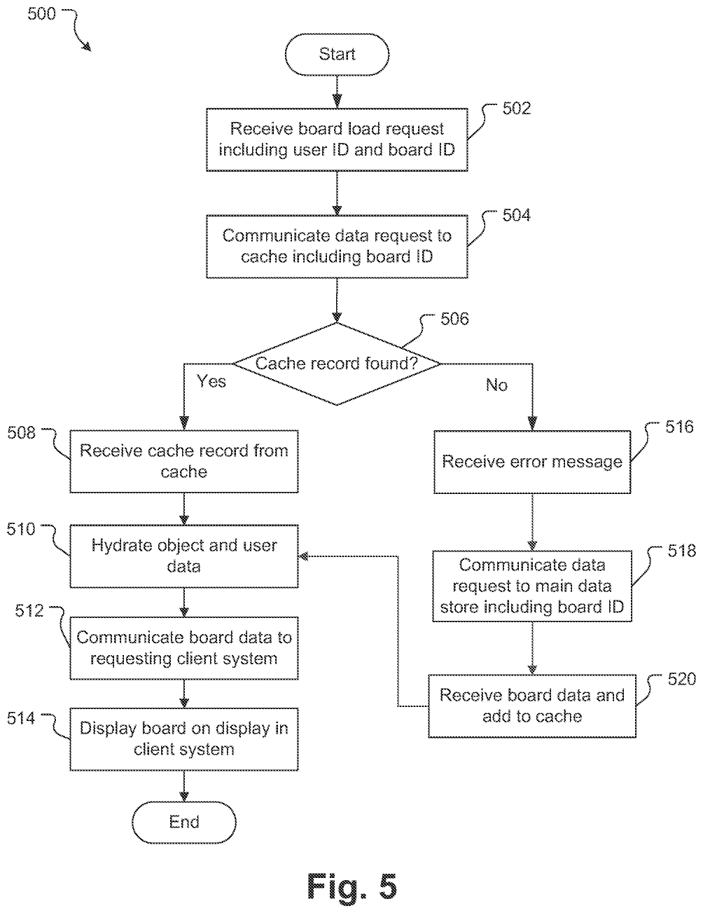

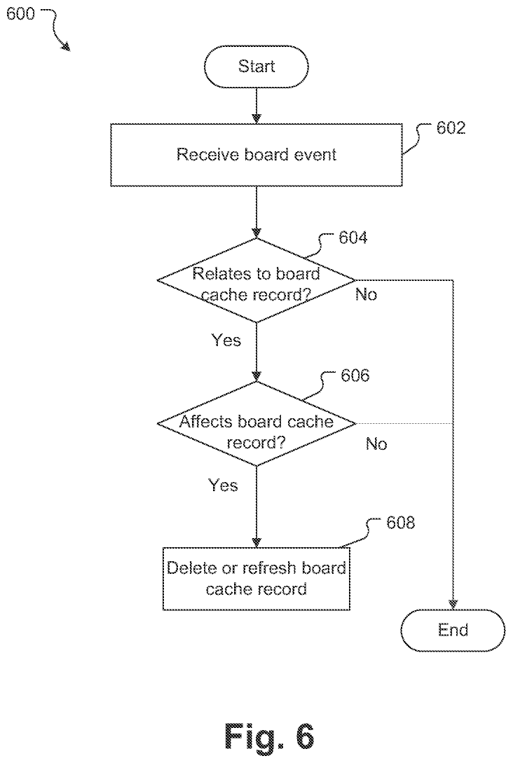

Various methods and processes for loading boards and maintaining board caches will now be described. In particular, FIG. 4 illustrates an example process for loading a board when per-user board cache records are employed, FIG. 5 illustrates an example process for loading a board when per-board cache records are employed and FIG. 6 illustrates an example process for updating a board cache record according to aspects of the present disclosure.

Although method 400 is described with reference to a single board loading request, it will be appreciated that in practice this method is repeated for every board load request.

The method 400 commences at step 402, where the cache manager 216 receives a board load request from a client system 220.

In some cases, a user may open the object tracking application (e.g., via a web browser or a dedicated application) and select a particular virtual board to be displayed (e.g., by selecting a suitable affordance, icon, tab, or performing a search using a search bar). When this happens, the client application 222 generates a board load request and communicates it to the server application 212. In other cases, the client application may automatically generate and send the board load request to the server application 212, for example, when a user logs into the object tracking application and the home page of the application is a virtual board user interface.

The board load request may include an identifier of the user account of the user that made the request. In some examples, if the user is a registered user of the object tracking application and has logged in before requesting to view a board, the user credentials (e.g., user name or user identifier) is communicated with the board load request. Alternatively, if the user is not a registered user of the object tracking application or has not yet logged in, a unique key may be generated for that particular client session and may be communicated to the server application 212 along with the board load request. In addition, the board load request may include a unique identifier associated with the board (e.g., a board identifier) the user wishes to view.

Upon receiving the board load request, the server application 212 communicates the request to the cache manager 216.

At step 404, the cache manager 216 checks whether a cache record for the requested board is present in the cache 218. When the cache 218 is used to store per-user board cache records, it may store data for each record under a combination of a user identifier of the user for whom the board is generated and a board identifier. For example, each stored board cache record may have an identifier as follows—

board/${BoardId.}/${user.id}

At step 404, the cache manager 216 communicates a data request to the cache 218. The data request includes the combination of the user identifier and board identifier received as part of the board load request.

At step 406, the cache 218 determines whether a cache record is found for the data request. To this end, the cache 218 compares the received combination of user identifier and board identifier with the identifier of the stored board cache records to determine whether a cache record for the requested board is stored in the cache 218 for the requesting user. If a match is found, the cache 218 determines that the cache record is present in the cache 218 and the method proceeds to step 408 where the cache 218 retrieves the identifier board cache record and communicates it to the cache manager 216.

In one example, the cache 218 creates a file (e.g., an XML or JSON file) of the board cache record and communicates this file to the cache manager 216. Table A below shows an example of the cache record file communicated by the cache 218 to the cache manager 216 at step 408.

TABLE A
Example per-user board cache record file

```
[ari:cloud:jira-
software:$cloudId:board/${monolithBoardId.id}/${user.aid}]:
{
  ″boardobjects″: {
    ″objects″: [
      {
        ″id″: 13318,
        ″key″: ″LI-17,”
        ″summary″: ″asdf,”
        ″objectTypeId″: 10005,
        ″estimateValue″: null,
        ″estimateText″: null,
        ″assigneeId″: null,
        ″flagged″: false,
        ″statusId″: 10004,
        ″parentId″: null,
        ″labels″: [ ],
        ″isDone″: false,
        ″color″: null,
        ″childrenIds″: [ ],
        ″childrenInfo″: {
          ″todoStats″: {
              ″objectCount″: 0
          },
          ″inProgressStats″: {
            ″objectCount″: 0
          },
          ″doneStats″: {
            ″objectCount″: 0
          },
          ″lastColumnObjectStats″: {
            ″objectCount″: 0
          }
        },
          ″priorityName″: null,
        ″priorityUrl″: null,
        ″isoDueDate″: null,
        ″isoStartDate″: null,
        ″fixVersions″: null
      },
      ... other objects
    ],
    ″assignees″: [
      {
        ″key″: ″admin,”
        ″name″: ″John Doe,”
        ″assigneeAccountId″: ″38472984723847,”
        ″avatarUrl″: ″https://secure.gravatar.com/avatar/37462986.png,”
        ″hasCustomUserAvatar″: false,
        ″auto UserAvatarModel″: null
        },
      ... other assignees
    ]
  },
  ″objectParents″: [
    {
      ″id″: 13447
      ″key″: ″LI-32,”
      ″summary″: ″my epic 2,”
      ″objectTypeId″: 10115,
      ″estimateValue″: null,
      ″estimateText″: null,
      ″assigneeId″; null,
      ″flagged″: false,
      ″statusId″: 10004,
      ″parentId″: null,
      ″labels″: [ ],
      ″isDone″: false,
      ″color″: null,
      ″childrenIds″: [
        13456,
        13448,
        13452,
      ],
      ″childrenInfo″: {
        ″todoStats″: {
          ″objectCount″: 3
        },
        ″inProgressStats″: {
          ″objectCount″: 0
        },
        ″doneStats″: {
          ″objectCount″: 0
        },
        ″lastColumnObjectStats″: {
          ″objectCount″: 0
        }
      },
      ″priorityName″: null,
      ″priorityUrl″: null,
      ″isoDueDate″: null,
      ″isoStartDate″: null,
      ″fixVersions″: null
    }
    ...other object parents
  ],
  ″childrenObjects″: {
    ″objects″: [ ],
    ″assignees″: [ ]
  },
  ″clearedObjects″: {
    ″hasClearedObjects″: true
  }
}
```

As seen in table A, the document includes not only the identifiers of the objects present in the board, but also includes object data (e.g., object name, object type, object status, assignee, parent objects, children objects, etc.).

At step 410, the cache manager 216 communicates the board data file to the server application 212, which communicates it to the client system 220 that requested the board data.

At step 412, the client application 222 renders the board user interface based on the board file and displays the virtual board (e.g., board 100) on a display of the client system 220.

Returning to step 406, if at this step, the cache 218 does not find a match for the combination of board identifier and user identifier, it determines that a board cache record is not present in the cache for that combination of user identifier and board identifier and generates and communicates an error message to the cache manager 216 at step 414.

Upon receiving the error message, the cache manager 216 is configured to communicate a data request to the data store 214 (at step 416). The data request includes the combination of the user identifier and board identifier received as part of the board load request.

At step 418, the data store 214 retrieves board data for the requested board. For example, the DBMS of the main data store 214 may first query the board database 215 for the board scope data for the given board identifier. Next, it performs a lookup for the objects present in the board scope. It then queries the object database 213 for the object identifiers found in the board scope record. It may also identify the assignee identifiers associated with the board from the board scope record and retrieve user data for those assignee identifiers from the identity database 219. Further, the DBMS may query the permissions database 217 to determine whether the user identifier received as part of the data request has permissions to view/edit the object data retrieved from the object database 213. To this end, the DBMS communicates the object identifiers and user identifier to the permissions database 217. The permissions database 217 may then return a list of objects the user is allowed to view and/or edit.

If there are any objects in the board the user is not allowed to view and/or edit, the DBMS removes those objects from the board data and communicates the rest of the board data to the cache manager 216. In one example, the board data communicated by the main data store 214 to the cache manager 216 may be similar to the board data shown in table A.

At step 418, the cache manager 216 receives the board data and adds the board data to the cache 218. In one example, a new cache key is created. The cache key may be based on the board identifier and the user identifier (as described above). Alternatively, the cache key may a randomly generated unique key that is later associated with the board identifier and user identifier combination. In one example, when storing the received board data under the new cache key, a TTL may also be set for that particular cache key. In one example, the TTL may be set for a few seconds (e.g., 10-15 seconds). At the expiry of this time period, the cache key may be deleted.

The method then proceeds to step 410, where the cache manager 216 communicates the board data to the server application 212. Thereafter, the method proceeds as described above.

If the client system 220 makes a request for board data again, e.g., to load non-critical elements or because server side rendering of the board timed out, the cache manager 216 once again determines whether a board cache record exists in the cache 218 for that combination of board identifier and user identifier (e.g., if the cache key has not yet expired). If the record exists, it is retrieved from the cache and served to the requesting system. Otherwise, it is once again retrieved from the main data store 214, stored in the cache 218 (e.g., with a new cache key and TTL timer) and served to the requesting system.

In the per-board cache record example, because different users of a given board may have different permissions, all users may not be able to see the same board data. For example, a task board may be setup for an entire team of users, however, each team member may only have permission to see tasks assigned to them. Similarly, in another example, a board that shows the currently pending issues managed by an entire service desk may include information about all the currently pending issues as they progress through workflow states. However, it may restrict access to issues based on team information. For example, an HR team member may only be able to view HR issues, and an IT team member may only be able to view IT-related issues, and so on. Because of this, although the cache 218 may store a board cache record for an entire board, the cache manager 216 may filter this record based on user permissions before communicating board data to requesting users.

Further, as multiple users may request the same board, embodiments of the present disclosure maintain the per-board cache records for a longer duration than the per-user board cache records. However, as the boards are maintained for a longer period of time, mechanisms have to be adopted to ensure the board cache records are up-to-date and not serving stale data to client systems.

Generally speaking, there are two types of data updates that may occur in a board—updates to the board and updates to the objects displayed within the board. Updates to the board include, e.g., addition or deletion of a card in the board. Updates to the objects displayed within the board may include, e.g., changes to the objects represented by the cards 110 within the boards (e.g., an object may be assigned to a different user, the description of an object may be updated, the status of an object may be updated, a complete by date may be changed, etc.). To account for updates to the objects displayed within the board, in some embodiments, object data and user data is not stored in the cache 218. Instead, this data may be fetched from the object database 213 and identity database 219 whenever a board load request is received. The object and identity databases 213, 219 may store updated object and user data. This way, whenever a board load request is received, the cache manager 216 can retrieve the latest object and identity data for the board from these databases.

To account for updates in board data, the cache manager 216 may subscribe to the event system 230. In particular, it may subscribe to receive board events. If a particular board is updated, e.g., because a new object is added or an object is deleted, event data for that update may be pushed to the cache manager 216. The cache manager 216 can then decide to delete the corresponding board cache record or update the board cache record—e.g., by adding or removing the object identifiers stored in the cache for the corresponding board.

In one example, the cache 218 may maintain a database of board cache records. For each board cache record, the database may maintain a board identifier (this may be the same as that maintained by the main data store), board name, and a time stamp indicating the date/time the board was last updated in the cache. In addition, for each board cache record, the database may maintain a list of object identifiers (of objects present in the board) and user identifiers (of assignees of objects in the board). Further, it maintains a timestamp indicating when each corresponding object or user identifier was last updated. Table B shows an example board record maintained by the cache 218.

TABLE B
example per-board cache record

```
[$cloudId:${boardId.id}]:
{
  strategy: {
    name: ″list-based-board-level,”
    lastupdate: 1637540113
  }
  contents: {
    lists: {
      boardObjects: {
        Objects: [123, 234], ([objectIds])
        assignees: [′aid-1′], (user keys)
        lastupdate: 1637540113
      },
          {
      childrenObjects: {
        objects: [123, 234], ([objectIds])
        assignees: [′aid-1′], (user keys)
        lastupdate: 1637540113
      },
      objectParents: {
        objects: [465, 24], ([objectIds])
        lastupdate: 1637540113
      },
      clearedObjects: {
        ″hasClearedObjects″: false,
        ″lastupdate″: 1637540113
      }
    },
  }
}
```

When compared to the board record maintained in the cache for a per-user cache record, it becomes clear, that the cache 218 maintains much lesser board data in the case of per-board cache records. Instead of maintaining the data associated with each of the objects and assignees, it simply stores the object and user identifiers of the cards present in the board. The actual object and/or assignee data for the individual cards can be retrieved from other data sources.

FIG. 5 is a flowchart illustrating another example method 500 for responding to a board load request. This flowchart describes the method performed when the cache 218 stores per-board cache records instead of per-user board cache records.

Similar to method 400, method 500 commences, at step 502, where the cache manager 216 receives a board load request from a client system 220. This is similar to step 402 and therefore is not described here again.

At step 504, the cache manager 216 checks whether data for the requested board is present in the cache 218. When the cache 218 is used to store per-board cache records, it may store data for each board under the board identifier. For example, each stored board cache record may have an identifier as follows—
board/${BoardId.id}

Accordingly, at step 504, the cache manager 216 communicates a data request to the cache 218. The data request includes the board identifier received as part of the board load request.

At step 506, the cache 218 determines whether a cache record is present corresponding to the received data request. In particular, the cache 218 compares the board identifier received in the data request with board identifiers stored in the cache 218. If a match is found, the cache 218 determines that a cache record exists and the method proceeds to step 508 where the cache 218 retrieves the corresponding board cache record and communicates it to the cache manager 216. In one example, the cache 218 creates a file (e.g., an XML or JSON file) of the board data corresponding to the requested board identifier and communicates this to the cache manager 216. In one example, the file may be similar to that shown in Table B.

At step 510, the cache manager 216 hydrates the object data and user data for the board. In particular, the cache manager 216 retrieves object data and user data for the objects and user identifiers present in the board cache record received from the cache 218. In one example, in order to do this, the cache manager 216 retrieves the object identifiers present in the received board file and communicates these object identifiers along with the user identifier of the user that requested the board to the permissions system 320 to determine whether the requesting user has permission to view/edit the objects present in the board. The permissions system 320 may return a response indicating which object identifiers the user has permission to view/edit and which object identifiers the user does not have permission to view/edit. The cache manager 216 may filter the object identifiers based on this permissions response—e.g., it may remove the object identifiers that the user does not have permission to view/edit and communicate an object data request for the remaining object identifiers to the object database 213. The object database 213 retrieves object data corresponding to the received object identifiers and provided this data back to the cache manager 216.

Simultaneously or subsequently, the cache manager 216 communicates a user data request to the identity system 330 that includes the user identifiers received in the board file from the cache 218. The identity system 330 returns the requested user data (e.g., user name, profile picture (if available), etc.) to the cache manager 216.

Upon receiving the object data (that the requesting user is permitted to view/edit) and the user data, the cache manager 216 is configured to add this data to the board file received from the cache 218 and communicate the hydrated board file to the server application 212 at step 512. For example, it may include the object data for each of the object identifiers the user is permitted to view. Further, it may add user data (e.g., assignee data) for each of the object identifiers the user is permitted to view. It will be appreciated that once the board data is hydrated, it may be similar to the board data shown in table A.

At step 512, the server application 212 communicates the board data to the client system 220 that requested it.

At step 514, the client application 222 renders the board user interface based on the board data and displays the board on a display of the user device.

Returning to step 506, if at this step, the cache 218 does not find a match for the board identifier, it determines that a board cache record is not present in the cache 218 and communicates an error message to the cache manager 216 at step 516.

Upon receiving the error message, the cache manager 216 is configured to communicate a data request to the main data store 214 at step 518. The data request includes the board identifier received as part of the board load request.

The main data store 214 then retrieves board data for the requested board and communicates it to the cache manager 216. Instead of retrieving all the board data for a given user, the data store 214 may simply retrieve the board scope data from the board database and communicate it to the cache manager 216. The board scope data includes the metadata about the board and a list of object and assignee identifiers associated with the board.

At step 520, the cache manager 216 receives the board scope data and adds it to the cache 218, and in particular to the database of cache records maintained by the cache 218. In one example, a new cache key is created. The cache key may be based on the board identifier. Alternatively, the cache key may a randomly generated unique key that is later associated with the board identifier. In one example, when storing the received board data under the new cache key, a TTL may also be set for that particular cache key. The TTL may be set for a predetermined time period (e.g., 6 hours, 12 hours, 24 hours, etc.). At the expiry of this time period, the cache key may be deleted.

Before adding the board scope data to the cache 218, the cache manager 216 may process the data. For example, it may retrieve the object identifiers of objects present in the board and add these to the cache record. Further, it may create a user list based on the assignee identifiers received as part of the board scope. In particular, if multiple objects are assigned to the same user, there may be multiple assignee records in the board scope data for the same user. The cache manager 216 may remove any duplicates such that it creates a user list of unique user identifiers that represent all the current assignees on the board. This user identifier list is also added to the cache record.

The method then proceeds to step 510, where the cache manager 216 hydrates the board scope data. Thereafter, the method proceeds as described above.

If another client system 220 requests the same virtual board, the cache manager 216 once again determines whether a board cache record exists in the cache 218 for that board identifier. If the record exists, it is retrieved from the cache 218 and served to the requesting system. Otherwise, it is once again retrieves from the main data store 214, stored in the cache (e.g., with a new cache key and TTL timer), hydrated and served to the requesting system.

### Example Method for Invalidating/Updating Cache

Generally speaking, to ensure that the data stored in the cache 218 is not out of data, the cache 218 may employ a number of policies. A first policy may be to evict data that is not requested in a threshold period of time from the cache 218. In one example, the eviction policy may be time-based—that is, a cache record may be evicted, e.g., after a period of time (e.g., 6 hours, etc.) has passed since the last read occurred on that board.

A second policy, as discussed above, may be to employ a TTL. No matter how often a board record is read from the cache 218, at the expiry of the predetermined period set for TTL, the cache record is deleted.

A third policy may be to update a board cache record or to evict the board cache record if the record is determined to be stale. In one example, if the cache manager 216 determines that a particular board cache record has been updated since it was stored in the cache 218, the cache manager 216 may be configured to either cause that record to be deleted from the cache or cause it to be updated. In some embodiments, per user board cache records may be deleted upon determining that the board has been updated since it was stored in the cache and per board cache records may be updated upon determining that the board has been updated since it was stored in the cache.

FIG. 6 illustrates an example method for doing this—e.g., updating or invalidating a per board cache record.

The method 600 commences when a board event is generated. As noted previously, users (on their client systems 220 and through an associated user account) interact with virtual boards, e.g., board 100. When a user account interacts with a board, a board event is generated. As referred to herein, a board event may be any interaction between a user account and a virtual board. Examples of board events include, without limitation: adding a card to a board, deleting a card from a board, moving a card from one column to another, updating a particular card—e.g., updating an assignee of a card, updating a card title/description, etc. This list of example board events is non-exhaustive and any other type of interactions with the boards can also be considered within the scope of the term “board event.”

Once the board event is generated, e.g., once the server application 212 generates information in respect of the event generated at a client system 220 (in the form of an event record), it forwards the event record to the event system 230. The event system 230 then checks the event record to determine if the cache manager 216 has subscribed to any of the information present in the event record (e.g., if the cache manager 216 has subscribed to receive board events). If the event system 230 determines that the cache manager 216 has subscribed to information in the event log, the event system 230 pushes the event record to the cache manager 216.

In one example, the event record includes at least an identifier of the board associated with the event, the type of interaction (e.g., object added, object removed, task completed, etc.), the affected object identifiers.

At step 602, the cache manager 216 receives the board event record from the event system 230.

At step 604, the cache manager 216 determines whether the event record relates to a board cache record in the cache 218. To this end, the cache manager 216 inspects the event record to retrieve the board identifier present in the record and performs a lookup of the board identifier in the cache 218. If the cache 218 returns data, the cache manager 216 determines that the board event record relates to a board cached in the cache 218. Alternatively, if the cache 218 returns an error, the cache manager 216 determines that the event record does not relate to any board cache records in the cache 218.

If at step 604, a determination is made that the event record is related to a board cache record, the method proceeds to step 606 where the cache manager 216 determines whether the event record affects the board cache record. As described previously, the cache 218 may not store all the board data. Instead, it may only store a list of object identifiers and assignee identifiers associated with the board. Other object and user related data in not stored in the cache but retrieved from the object database 213 or identity database 219 on the fly. Accordingly, if the event record is related to a change in object data (e.g., a change in an issue title/description, completion date, etc.), the corresponding cache record remains unaffected. Alternatively, if an assignee for an object has been updated, a new object is added to the board, or an object is removed from the board, the board cache record is affected.

In one example, at step 606, the cache manager 216 inspects the interaction type field of the event record to check whether the interaction type of the event affects the board cache record or not. To this end, the cache manager 216 may store a list of interaction types that affect the board cache (e.g., assignee added, assignee updated, object added, object deleted) and may compare the interaction type field of the event record with the stored list of interaction types. If the event record's interaction type matches an interaction type in the list, the cache manager 216 determines that the event record affects the corresponding board cache record. Otherwise, it determines that it does not.

At step 606, if a determination is made that the event record affects the cached board data, the method proceeds to step 608, where the corresponding board cache record is deleted from the cache 218 or updated. In case the record is to be deleted, the cache manager 216 may simply issue a delete command (that includes the cache key of the record). Upon receiving this command, the cache 218 deletes the corresponding cache key.

Alternatively, if the board cache record is to be updated, the cache manager 216 may generate a command to update the corresponding board cache record and communicate this command to the cache 218. For example, if the event record indicates that a new object is added to the board, a command to add the object identifier of the new object to the board cache record is generated. If available, the command may also include the identifier of a user that is assigned to the object. Upon receiving the command, the cache 218 updates the corresponding record to include the object identifier and/or user identifier received as part of the command. Further, the last updated field for the record is updated to the current time. In some examples, the TTL for the record may also be restarted. Similarly, if an event record indicates that the assignee for a particular object has changed, a command to update the user list maintained for that board cache record may be generated. The command includes the identifier of the board cache record and the identifier of the updated assignee. Upon receiving this command, the cache 218 may determine whether the identifier of the updated assignee is already present in the board cache record. If the identifier is already present, it may not do anything. Alternatively, if the identifier is not already present in the list of user identifiers, the cache 218 adds the user identifier of the updated assignee to the list of user identifiers.

This way, board cache records can be updated directly based on received event records without needing to retrieve this updated data from the main data store. This further reduces the burden on the main data store.

Returning to step 606, if it is determined that the event record does not affect the cached board data, method 600 ends. Similarly, at step 606, if it is determined that the event record is not related to the board cache record, the method 600 ends.

It will be appreciated that method 600 is described with reference to a single board event record. However, in actual implementation, the cache manager 216 receives multiple such event records and performs steps 604-608 for each of these records.

### ALTERNATE EMBODIMENTS

FIG. 6 illustrates a method where a board cache record is deleted or updated based on monitored board events. In addition to this, the presently disclosed systems may be configured to update or delete cache records based on data update requests received from client systems 220. For example, a user of a client may move a card 110 from one column to another. For example, a user may change the assignee for Task 8 card in board 100. In such cases, the client application 222 generates a request to update board data and object data in the main data store 104 (and in particular in the board database 215 and the object database 213). The client application 222 communicates this update request to the server application 212. Typically, the server application 212 generates a write request based on this and communicates it to the DBMS of the data store 214, which writes the data to the corresponding board and object databases. In addition to this, according to some embodiments, the server application 212 also generates and communicates a write request to the cache manager 216. The cache manager 216 then communicates this write request to the cache 218. If a corresponding board cache record exists in the cache 218, it is then updated as described above. Otherwise, the cache 218 returns an error message notifying the cache that a corresponding record does not exist in the cache to update.

In the methods described above it is assumed that either the cache 218 stores per-user cache records or it stores per-board cache records. However, in some embodiments, the cache 218 may store a combination of per-user cache records and per-board cache records. In such cases, the cache manager 216 may query the cache 218 using both the combination of user identifier and board identifier and the board identifier by itself. If the cache 218 returns a board file in response to either of those queries, the cache manager 216 determines whether the board file needs to be hydrated (in case it corresponds to a per-board cache record), and either hydrates the board file (if it corresponds to a per-board cache record as described in step 510) or directly communicates the board file to the client device (if it corresponds to a per-user board cache record). Further, if the cache 218 does not return a board file for either of the queries, the cache manager 216 may retrieve board data from the main data store as described with respect to method 400 or as described with respect to method 500.

Further, in the systems described above, it is assumed that queries are communicated to the object database 213 and the permissions database 217 independently. However, this need not be the case in all embodiments. Instead, in some embodiments, a single query may be communicated to the data store 214. The DBMS of this data store may then query the two underlying databases (e.g., the object database 213 and the permissions database 217) concurrently. In this case, the cache manager 216 may communicate a single query to the DBMS that includes the requested object identifiers and user identifier of the requesting user and the DBMS may be configured to query the two underlying databases and return object data only for the object identifier the user identifier has permission to view/edit.

Further still, the per-board cache records are described as including object identifiers and assignee identifiers. However, in some cases, the object database 213 and the entity databases 219 may be combined. In such cases, the cache 218 only needs to store the object identifiers of objects present in the board. When object data for these identifiers is hydrated, the corresponding assignee information may also be retrieved from the object database 213. In such examples, the cache manager 216 would not need to make two separate calls to the object database 213 and identity database 219.

The flowcharts illustrated in the figures and described above define operations in particular orders to explain various features. In some cases the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by different systems or applications. For example, in method 600, steps 604 and 606 may be interchanged or combined in a single step.

Unless otherwise stated, the terms “include” and “comprise” (and variations thereof such as “including,” “includes,” “comprising,” “comprises,” “comprised” and the like) are used inclusively and do not exclude further features, components, integers, steps, or elements.

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage or attribute that is not expressly recited in a claim should be considered as a required or essential feature. Accordingly, the specification and drawings are to be regarded in an illustrative rather than a restrictive sense.

What is claimed is:

1. A computer-implemented method, comprising:
receiving a board load request from a client device, the board load request comprising a board identifier of a requested board;
determining whether a cache record for the requested board is present in a board cache;
upon determining that the cache record for the requested board is present in the board cache, receiving the cache record from the board cache, the cache record comprising identifiers of one or more objects present in the board;
retrieving object data for at least a subset of the one or more objects present in the board;
hydrating the cache record based on the retrieved object data; and
communicating the hydrated cache record to the client device for rendering the requested board on a display of the client device.

2. The computer-implemented method of claim 1, wherein the board load request further comprises a user identifier of the user that requested the board; and
wherein retrieving the object data for the one or more objects present in the board comprises communicating the user identifier and the identifiers of the one or more objects to a permissions database to determine whether the user that requested the board has permission to view the one or more objects.

3. The computer-implemented method of claim 2, further comprising:
determining that the user that requested the board has permission to view at least the subset of the one or more objects in the board; and
retrieving the object data for at least the subset of the one or more objects from an object database.

4. The computer-implemented method of claim 1, further comprising:
upon determining that the cache record for the requested board is not present in the board cache, generating and communicating a data request to a main data store, the data request comprising the board identifier;
receiving board scope data from the main data store, the board scope data comprising identifiers of one or more objects present in the board; and
creating and storing a board cache record in the board cache, the board cache record comprising the identifiers of the one or more objects present in the board.

5. The computer-implemented method of claim 4, wherein the board scope data comprises user identifiers of one or more user assigned to the one or more objects present in the board, and the method further comprising storing the user identifiers in the board cache record.

6. The method of claim 1, wherein the cache record further comprising one or more user identifiers of users that are assigned to the one or more objects in the board.

7. The method of claim 6, further comprising:
retrieving user data for the one or more user identifiers present in the board; and
hydrating the cache record based on the retrieved user data.

8. A non-transitory computer readable medium comprising instructions, which when executed by a processing unit cause a computer processing system to perform operations comprising:
receiving a board load request from a client device, the board load request comprising a board identifier of a requested board;
determining whether a cache record for the requested board is present in a board cache;
upon determining that the cache record for the requested board is present in the board cache, receiving the cache record from the board cache, the cache record comprising identifiers of one or more objects present in the board;
retrieving object data for at least a subset of the one or more objects present in the board;
hydrating the cache record based on the retrieved object data; and
communicating the hydrated cache record to the client device for rendering the requested board on a display of the client device.

9. The non-transitory computer readable medium of claim 8, wherein the
board load request further comprises a user identifier of the user that requested the board; and
wherein retrieving the object data for at least the subset of the one or more objects comprises communicating the user identifier and the identifiers of the one or more objects to a permissions database to determine whether the user that requested the board has permission to view the one or more objects.

10. The non-transitory computer readable medium of claim 9, further comprising instructions which when executed by the processing unit, cause the computer processing system to perform the operations comprising:
determining that the user that requested the board has permission to view at least the subset of the one or more objects in the board; and
retrieving the object data for at least the subset of the one or more objects from an object database.

11. The non-transitory computer readable medium of claim 8, further comprising instructions which when executed by the processing unit, cause the computer processing system to perform the operations comprising:
upon determining that the cache record for the requested board is not present in the board cache, generating and communicating a data request to a main data store, the data request comprising the board identifier;
receiving board scope data from the main data store, the board scope data comprising identifiers of one or more objects present in the board; and
creating and storing the cache record in the board cache, the cache record comprising the identifiers of the one or more objects present in the board.

12. The non-transitory computer readable medium of claim 11, wherein the board scope data comprises user identifiers of one or more user assigned to the one or more objects present in the board, and further comprising instructions which when executed by the processing unit, cause the computer processing system to store the user identifiers in the cache record.

13. The non-transitory computer readable medium of claim 8, wherein the cache record further comprising one or more user identifiers of users that are assigned to the one or more objects in the board.

14. The non-transitory computer readable medium of claim 13, further comprising instructions which when executed by the processing unit, cause the computer processing system to perform the operations comprising:
retrieving user data for the one or more user identifiers present in the board; and
hydrating the cache record based on the retrieved user data.

15. The non-transitory computer readable medium of claim 8, further comprising instructions which when executed by the processing unit, cause the computer processing system to perform the operations comprising:
receiving a board event, the board event indicating an update to a board cache record of a plurality of board cache records maintained by the board cache; and
deleting the board cache record.

16. The non-transitory computer readable medium of claim 13, further comprising instructions which when executed by the processing unit, cause the computer processing system to perform the operations comprising:
receiving a board event, the board event indicating an update to a board cache record of a plurality of board cache records maintained by the board cache; and
updating the board cache record based on the board event.

17. The non-transitory computer readable medium of claim 16, further comprising instructions which when executed by the processing unit, cause the computer processing system to perform the operations comprising:
determining whether the update to the board cache record includes an update that affects the one or more object identifiers or the one or more user identifiers maintained in the board cache record; and
updating the board cache record upon determining that the update to the board cache records includes the update that affects the one or more object identifiers or the one or more user identifiers.

18. The non-transitory computer readable medium of claim 17, wherein the update affects the one or more object identifiers if the update adds a new object or deletes an existing object in the board.

19. The non-transitory computer readable medium of claim 17, wherein the update affects the one or more user identifiers if the update changes an assignee associated with an object of the one or more objects in the board.

20. The non-transitory computer readable medium of claim 15, further comprising instructions which when executed by the processing unit, cause the computer processing system to perform operations comprising:
determining whether the board event relates to any of the plurality of board cache records maintained by the board cache; and
ignoring the board event upon determining that the board event does not relate to any of the plurality of board cache records maintained by the board cache.
